(19) United States
(12) Patent Application Publication
(10) Pub. No.: US 2015/0363889 A1
(43) Pub. Date: Dec. 17, 2015

(54) Methods and Systems for Electronic Receipt Tracking, Storage, and Provision

(71) Applicant: Transyl Ventures LLC, Cheyenne, WY (US)

(72) Inventors: Mihai Levi Marian, Sugar Hill, GA (US); Richard D. Copeland, JR., Marietta, GA (US)

(21) Appl. No.: 14/725,736

(22) Filed: May 29, 2015

Related U.S. Application Data
(60) Provisional application No. 62/005,413, filed on May 30, 2014.

(51) Int. Cl. G06Q 40/00; G06Q 20/20; H04L 29/08; G06F 17/30

(52) U.S. Cl. CPC G06Q 40/12; G06F 17/30876; G06F 17/30882; G06Q 20/209; H04L 67/02

(57) ABSTRACT

Methods and systems for electronic receipt tracking, storage and provision may be provided. Embodiments of the methods may include receiving transactional data, generating a descriptor to be associated with the transactional data, and associating the descriptor with the transactional data. In some embodiments of the methods, associating the descriptor with the transactional data may further comprise transmitting transactional data to a transaction processor, receiving confirmation that a transaction associated with the data has been processed, and storing the descriptor with the confirmation.

### RELATED APPLICATION

Under provisions of 35 U.S.C. §119(e), the Applicants claim the benefit of U.S. provisional application no. 62/005413, filed May 30, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to electronic commerce.

### BACKGROUND

A receipt may serve as an acknowledgment that a specified article or sum of money has been exchanged for goods or services between at least two parties. It is most frequently embodied as a printed record given to a consumer at a point of sale. A receipt may list the purchases made and the corresponding prices, including tax, discounts and other adjustments, the amount paid, and the method of payment. As a legal contract, it is typical for that receipt to also include messages from the retailer, warranty or return details, special offers, advertisements or coupons.

Electronic payment transaction service providers (e.g., credit card companies, banks, and other financial institutions) may provide statements showing a brief description of an account holder's purchase history. Unlike receipts, however, these statements often lack specificity and the desired details for particular transactions. When account holders wish to review the specifics of the transactions listed in the statement, their only recourse may be to search and retrieve the corresponding physical receipts from their personal records.

Unfortunately, receipts are often seen as extraneous, difficult to store and retrieve, with limited available to consumers when they are needed for review and reference. In fact, many consumers rely on inexact, cumbersome, insecure and deeply fallible methods to store, search, and keep track of their receipt data. For example, email inboxes, shoeboxes, wallets, drawers, scanners, and cameras collectively comprise the desperate and disorganized set of systems and methods currently available for consumer's to store, search, and retrieve receipts. Further adding to their fallibility, these existing methods and systems require extra steps to be taken by the consumers after having received a physical receipt.

Nevertheless, the receipt serves an important and necessary purpose. For example, receipts may be relied upon to protect against overcharges or fraudulent activity. Moreover, in many countries, notably the United States of America, it may be mandatory by law for retailers and individuals to show receipts and store information about certain financial transactions so that the tax authority (i.e., IRS) may be enabled to perform audits in deterrence of fraud or tax evasion.

### BRIEF OVERVIEW

Methods and systems for electronic receipt tracking, storage, and provision may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure may include receiving transactional data, generating a descriptor to be associated with the transactional data, and associating the descriptor with the transactional data. In some embodiments of the methods, associating the descriptor with the transactional data may further comprise transmitting transactional data to a transaction processor, receiving confirmation that a transaction associated with the data has been processed, and storing the descriptor with the confirmation.

In further embodiments, associating the descriptor with the transactional data may comprise transmitting the transactional data to a transaction processor, receiving confirmation that a transaction associated with the transactional data has been processed, and storing the descriptor with the confirmation.

In further embodiments, generating the descriptor may comprise generating uniform resource locator (URL) associated with an electronic receipt corresponding to the transactional data.

In further embodiments, the methods may comprise providing the descriptor to a user, a group of users, or an account associated with the transactional data.

In some embodiments, providing the descriptor may comprise displaying the custom descriptor within a transactional statement associated with the user, the group of users, or the account associated with the transactional data.

In some embodiments, the methods may further comprise enabling a selection of the descriptor as a hyperlink pointing to a storage location, wherein the storage location may comprise an electronic receipt associated with the transactional data.

In some embodiments the methods may further comprise providing the electronic receipt data upon a selection of the hyperlink.

In some embodiments the methods may further comprise receiving an open tab indication, and wherein associating the descriptor with the transactional data may comprise associating, in response to the received open tab indication, the descriptor with a plurality of pre-authorized transactions.

In some embodiments the methods may further comprise storing the plurality of pre-authorized transactions and the corresponding descriptor as electronic receipt data. In some embodiments, the methods may further comprise parsing transactional data so as to retrieve the descriptor associated with the transactional data, locating, based on the descriptor, electronic receipt data, and associating the electronic receipt data with the transactional data.

In further embodiments, associating the electronic receipt data with the transactional data may comprise associating the transactional data with a uniform resource locator (URL).

In still further embodiments, the methods may further comprise providing transactional data in conjunction with a URL corresponding to the transactional data.

In further embodiments, receiving the transactional data may comprise receiving transactional data pertaining to a refund or a return.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates an online banking statement;

FIG. 3 illustrates the online banking statement using the ERT platform;

FIG. 4 is a flow chart for a point of sale checkout through the ERT platform;

FIG. 5 is a flow chart for an electronic checkout through the ERT platform;

FIG. 6 is a flow chart for opening a tab through the ERT platform;

FIG. 7 is a flow chart for updating a tab through the ERT platform;

FIG. 8 is a flow chart for closing a tab through the ERT platform;

FIG. 9 is a flow chart for modifying a tab through the ERT platform;

FIGS. 10-11 are flow charts for providing a receipt through the ERT platform;

FIG. 12 is a flow chart for receipt scanning through the ERT platform;

FIGS. 13-14 are flow charts for a payment processor of the ERT platform;

FIGS. 15-16 are flow charts for providing authorization in the ERT platform;

FIG. 17 is a flow chart for detecting and mitigating fraud through the ERT platform; and

FIG. 18 is a block diagram of a system including a computing device for performing the methods of the ERT platform.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of transaction receipts, embodiments of the present disclosure are not limited to use only in this context.

I. Platform Overview

Consistent with embodiments of the present disclosure, methods and systems for electronic receipt tracking, storage and provision may be provided. This overview is provided to introduce a selection of concepts in a simplified form that are further described below. This overview is not intended to identify key features or essential features of the claimed subject matter. Nor is this overview intended to be used to limit the claimed subject matter's scope. The methods and systems for electronic receipt tracking, storage and provision may be used by individuals or companies to provide a history of past transactions.

Consistent with embodiments of the present disclosure, an electronic receipt tracking (ERT) platform may comprise the computer-implemented methods and systems for electronic receipt tracking, storage, and provision. The ERT platform may be provided to enable consumer access to receipts and electronic purchase data over the internet. This may be accomplished through the creation and implementation of, for example, a receipt global unique identifier (RGUID). A RGUID may be created for each electronic payment transaction implementing the ERT platform.

The RGUID may be associated with data corresponding to transactions (hereinafter referred to as “receipt data”). Receipt data may comprise, but not limited to, for example, a listing of goods, services, and prices including tax, discounts and other adjustments, the amount paid, the method of payment, messages from the retailer, warranty or return details, special offers, advertisements and coupons.

In various embodiments of the present disclosure, the RGUID may be embodied in a uniform resource locator (URL). In turn, the URL may be provided to a consumer in a plurality of different ways. For example, in some embodiments, the URL may be listed within a statement provided to the consumer. The statement may comprise, but not be limited to, for example, an electronic statement provided to the consumer by the institution facilitating the electronic payment transaction for which the corresponding RGUID was created. When the consumer follows the listed URL to a website, the ERT platform may display the receipt data to the consumer. In this way, embodiments of the present disclosure may adapt existing financial statements with detailed receipt data where applicable.

In other embodiments, the receipt data may be provided directly though the ERT platform. For example, a user of the ERT platform may access a user profile comprising a dashboard that lists the user's electronic transactions as recorded by the RGUID. The list may comprise a brief description of each transaction in addition to the URL associated with the RGUID. The user may then select a particular transaction and, in turn, be provided with the receipt data associated with the RGUID.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

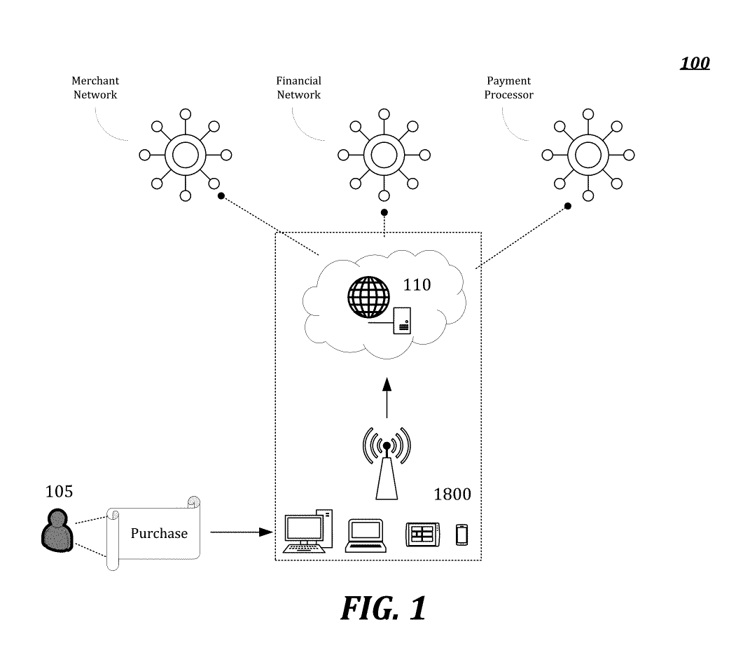

FIG. 1 illustrates one possible operating environment through which a platform consistent with embodiments of the present disclosure may be provided. By way of non-limiting example, an ERT platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 1800. One possible embodiment of the software application may be provided by the Synapp.io™ suite of products and services provided by Transyl Ventures LLC.

Consistent with embodiments of the present disclosure, the ERT platform may be configured at one or a plurality of nodes within a payment transaction network. The network may comprise, but not be limited to, for example, a merchant (e.g., point of transaction), payment processor, financial network (e.g., VISA/MASTERCARD), and a financial institution (e.g., a bank). The ERT platform may be configured at a node within the network in which it may intercept a sufficient amount of transactional data (i.e., the receipt data) associated with a transaction.

The intercepted transactional data may be transmitted to a data repository associated with the ERT platform. The ERT platform may process the transaction data received at the data repository. Processing may comprise an assignment of a RGUID to each processed transaction. The data repository may reside in a cloud-computing environment, either within or in remote communication to the payment transaction network. Details regarding the networking environment are described in the Platform Architecture section of this disclosure.

The processed transaction data may be compiled into a user-friendly form of receipt data that may be viewable on, for example, a website. Receipt data associated with the processed transactions may, in turn, be transmitted data back to a point within the payment transaction network. In some embodiments, the ERT platform may provide a bank with, for example, a URL linking to the website comprising the receipt data. The URL may then be listed in, for example, a monthly statement provided to the consumer.

In various embodiments, the ERT platform may process the transaction prior to the transaction record being transmitted beyond the point of transaction (e.g., merchant-side processing). For example, the ERT platform processing may be implemented and/or integrated into the point of sale system residing within the merchant's premises. For online-transactions, the ERT platform may be implemented within an e-commerce payment processing gateway. In these embodiments, the ERT platform may be integrated with an existing Application Programming Interfaces (APIs) to perform the transaction data processing for receipt data compilation. In this way, the nodes beyond the point of transaction (e.g., a payment processor or bank) may receive the transaction record along with a URL already generated by the ERT platform for the transaction.

Consistent with embodiments of the present disclosure, an end-user of the ERT platform may be, for example, a consumer making a purchase at the point of transaction. Conventional transactional methods provide the consumer with a receipt as evidence of the legally binding contract formed through the transaction. Having the ERT platform integrated within the payment transaction network, however, the consumer may now be further provided with a URL linking to the virtual receipt data derived, by the ERT platform, from the transaction. In some embodiments, the URL may be provided to the end-user within, for example, an itemized statement issued by a financial institution.

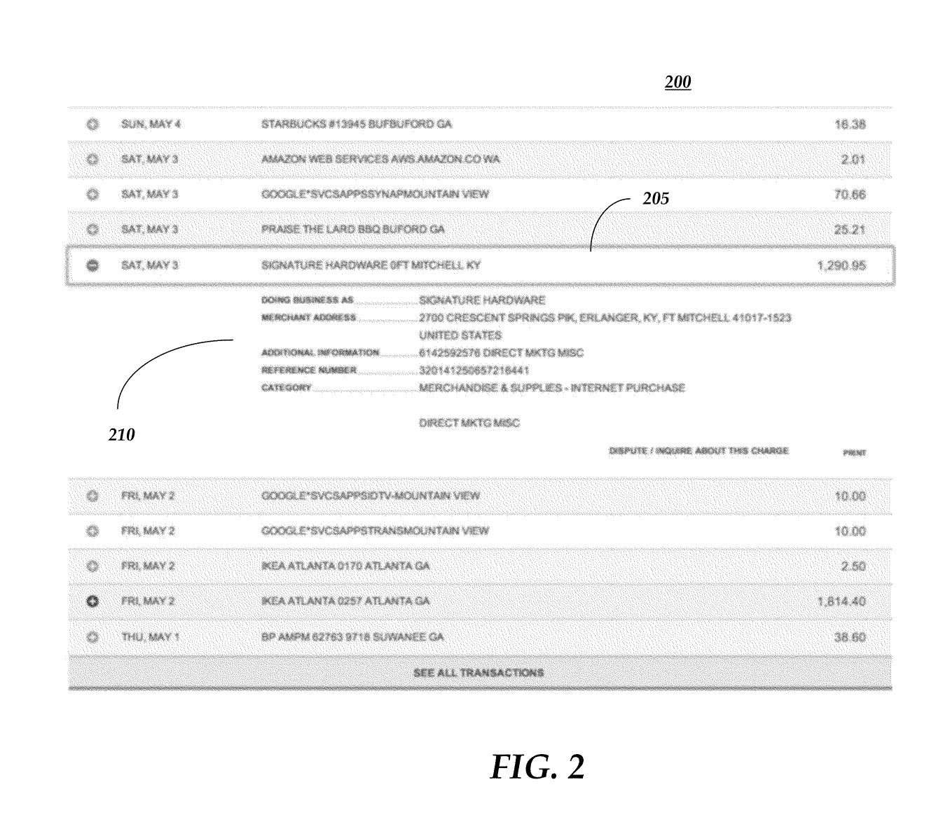

FIG. 2 illustrates an embodiment of an itemized, electronic statement 200. The electronic statement 200 may be provided to the end-user through, for example, a website hosted by a financial institution. As shown in FIG. 2, each line item of the statement may comprise a description field 205 that briefly describes various parameters of a listed transaction within the statement. When the user selects (or ‘clicks’) the description field 205, details 210 associated with the transaction may be displayed to the end-user.

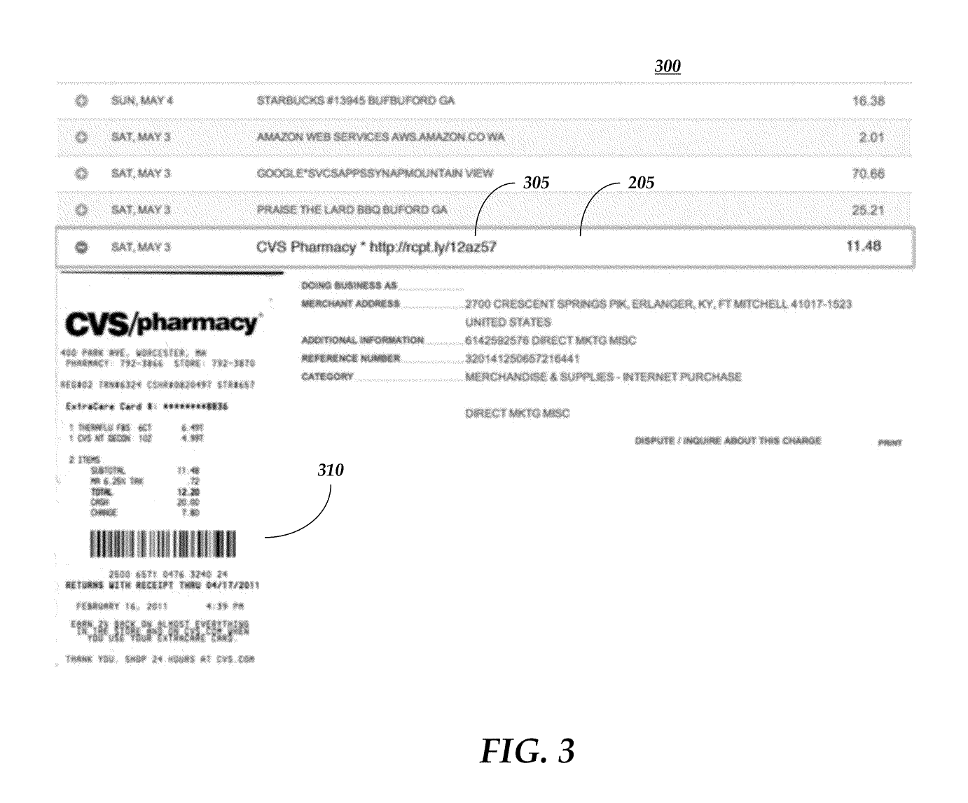

Consistent with embodiments of the present disclosure, the ERT platform may be employed to append or amend the description field 205 with the aforementioned URL. FIG. 3 illustrates an embodiment of an itemized, electronic statement 300. The description field 205, as shown in FIG. 3, may now comprise a URL 305. As mentioned above, the URL may comprise information corresponding to the RGUID assigned to the transaction by the ERT platform. When the user follows the URL 305, the user may be directed to a website that contains the receipt data associated with the transaction. In some embodiments, the website may be integrated within the same platform providing the electronic statement. Alternatively, the website comprising the receipt data may be hosted by a different provider, having its own set of verification credentials with independent accessibility and functionality.

Still consistent with embodiments, electronic statement 300 may display an embodiment of the receipt data 310 within the statement itself. In these embodiments, the ERT platform may be configured to provide the receipt data corresponding to the RGUID directly to the platform hosting the electronic statement 300. In this way, the end-user may be enabled to view the receipt data directly within the statement.

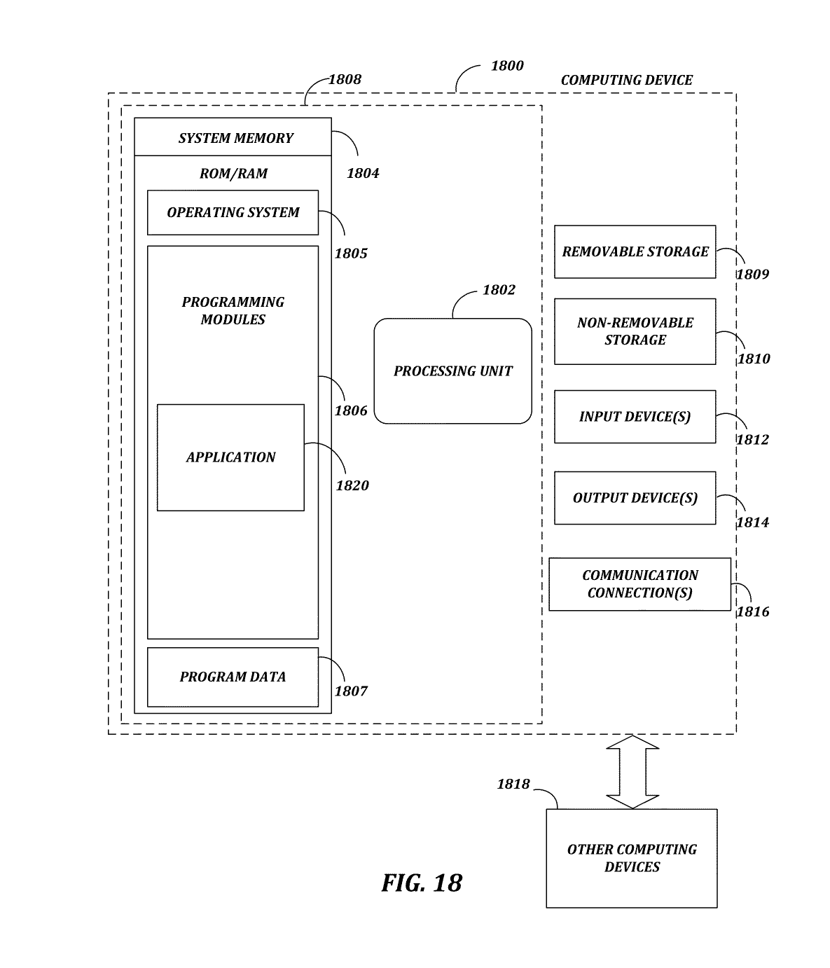

As will be detailed with reference to FIG. 18 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

III. Platform Operation

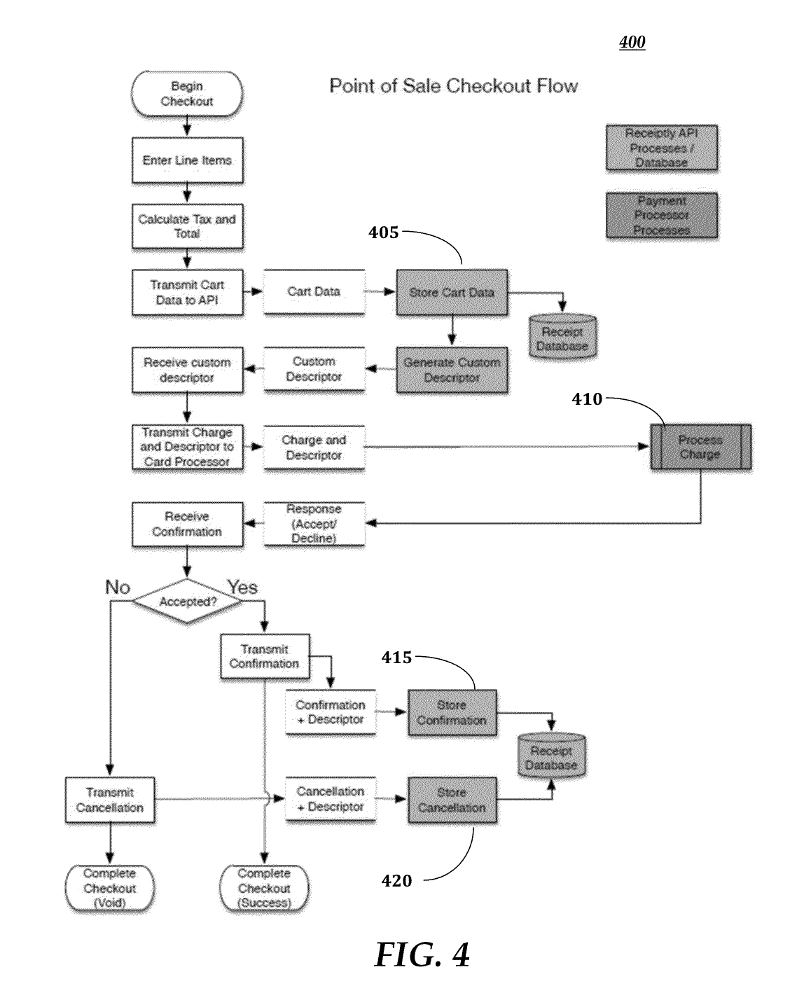

FIGS. 4-17 are flow charts settings forth the general stages involved in providing various computer-implemented methods and systems for electronic receipt tracking, storage and provision. The various methods and stages disclosed in FIGS. 4-17 may be implemented using a computing device 1800 as described in more detail below with respect to FIG. 18.

Although the flow charts have been described to be performed by a software application associated with an ERT platform, it should be understood that, in some embodiments, different operations may be performed by different networked elements in operative communication with the software application, such as, for example, computing device 1800. Furthermore, server 110 may be employed in the performance of some or all of the stages in the methods below. Moreover, server 110 may be configured much like computing device 1800 and, in some instances, be one and the same embodiment. Moreover, the ERT platform may be integrated into a various point of sale hardware, financial institution software, as well as e-commerce related platforms.

Though the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

FIG. 4 is a flow chart for a point of sale checkout through the ERT platform. In this chart, a cashier at the point of sale may enter the order into the point of sale system. Then, prior to charging the customer using, for example, but not limited to, a payment card, the point of sale system may be configured to submit the order (“cart data”) to the ERT system in stage 405. In turn, a custom descriptor containing the RGUID may be provided for use when actually charging the card. When a payment form for the customer (e.g., the payment card) is actually charged, the custom descriptor containing the RGUID may then be transmitted to the payment processor in stage 410, becoming a permanent record in the payment processor's database. If the charge is accepted, the ERT system may be notified of a complete transaction and the success of the transaction is recorded in the ERT database in stage 415. Likewise, if the charge is declined, the ERT database is updated to reflect this fact in stage 420.

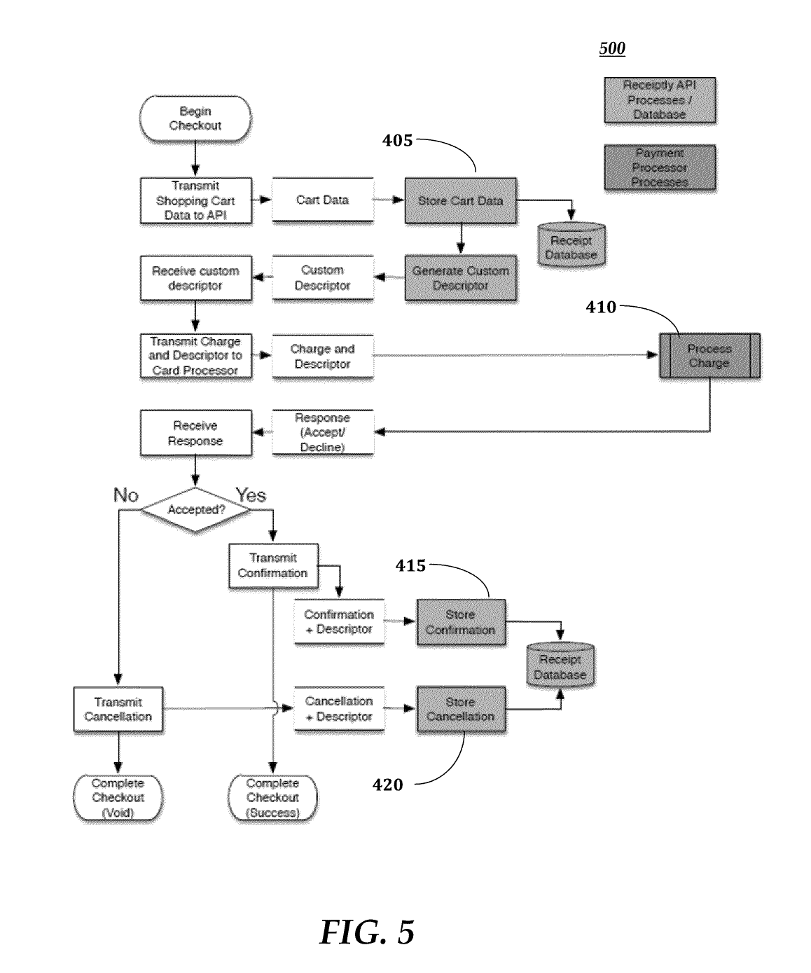

FIG. 5 is a flow chart for an electronic checkout through the ERT platform. In this chart, the cashier and the point of sale system of FIG. 4 is replaced by an e-commerce system which submits its cart data to the ERT.

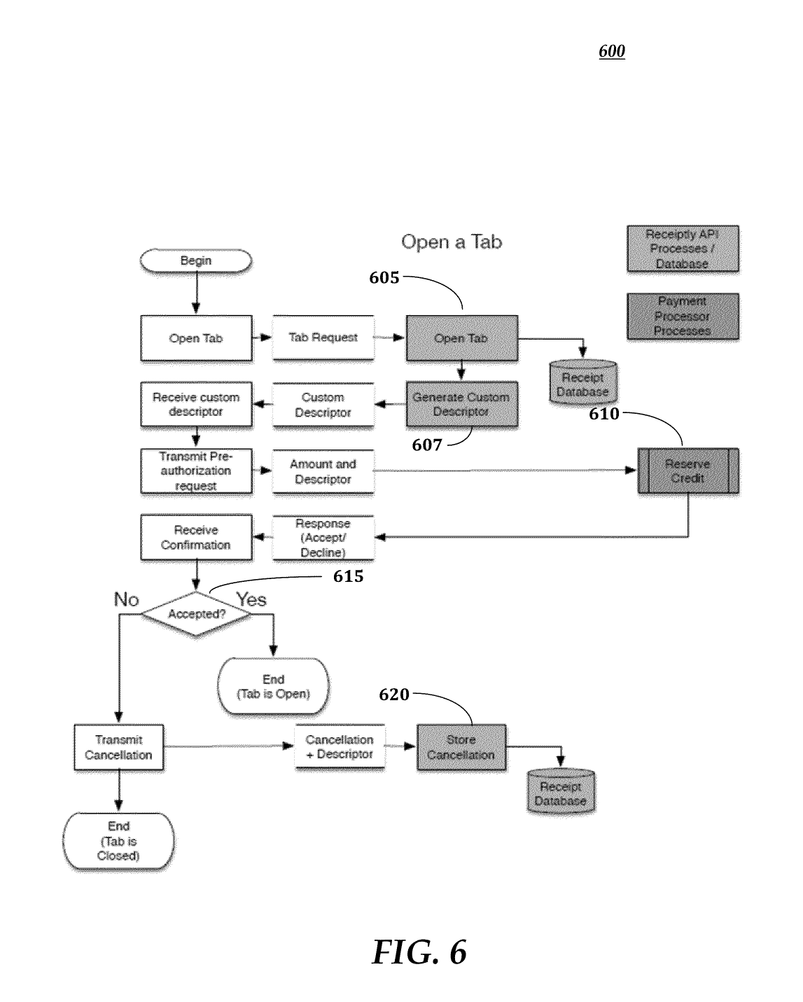

FIG. 6 is a flow chart for opening a tab through the ERT platform. In this chart, a consumer may wish to pre-authorize a card for purchases that occur over a period of time. In the absence of an ERT platform, such a tab may be opened by simply pre-authorizing the card for a certain amount. With the ERT platform, on the other hand, an open tab may be created in the ERT platform in stage 605 prior to the pre-authorization transmitted to the payment card processor in stage 610, generating a custom descriptor containing an RGUID for transmission, generated in stage 607, to the payment processor when performing the pre-authorization. If the pre-authorization fails, the ERT may receive notification of the failure and the open tab in the ERT may be closed out with a zero balance in stage 620.

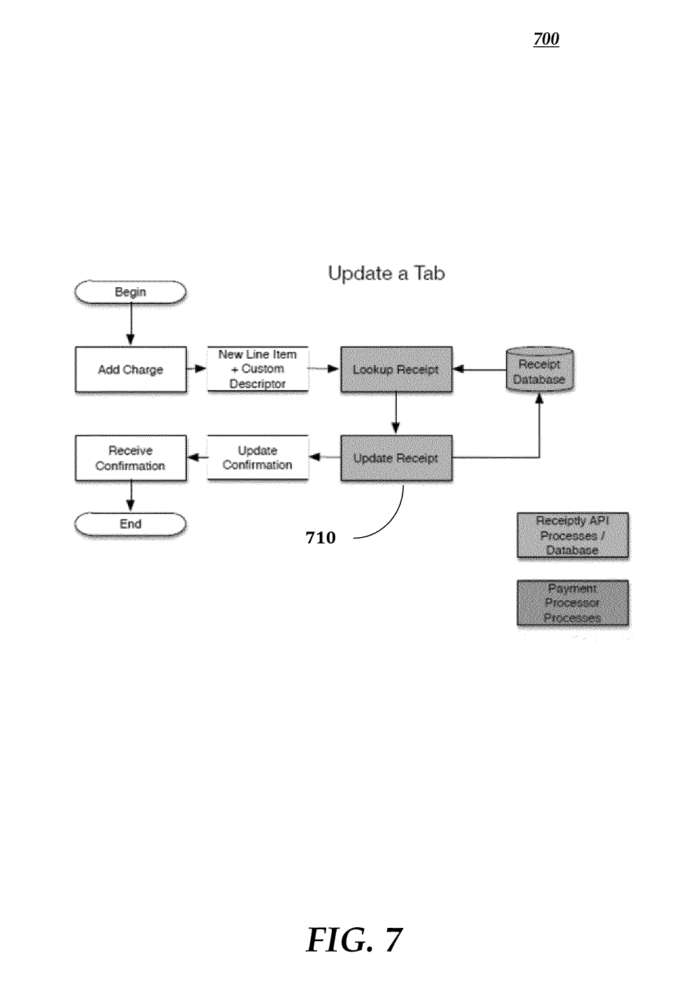

FIG. 7 is a flow chart for updating a tab through the ERT platform. When a tab has been previously opened in the ERT platform, each individual purchase that the customer performs may update the receipt data inside the ERT in stage 710, allowing the ERT to keep a detailed record of each individual purchase.

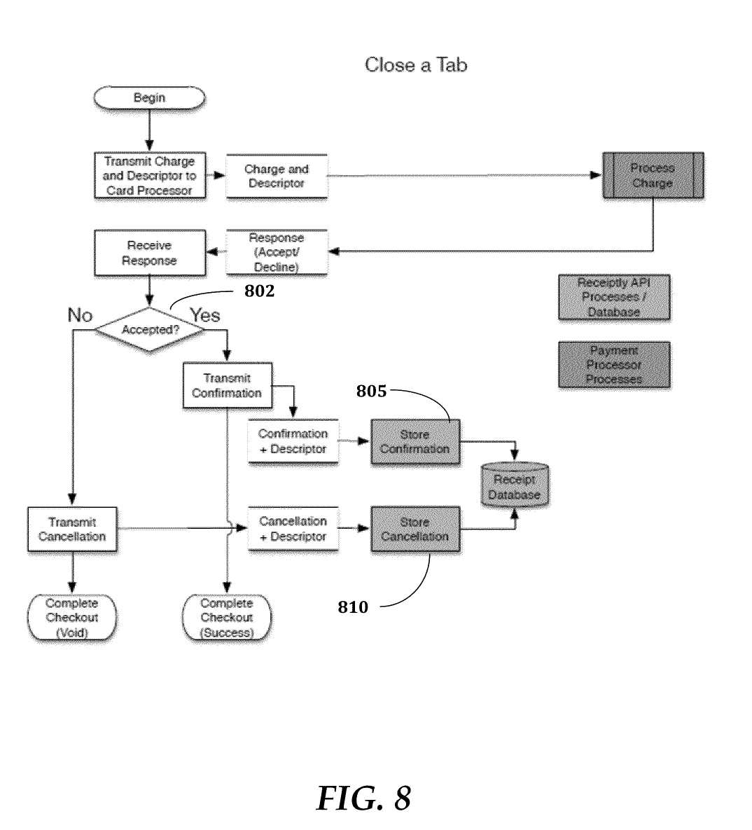

FIG. 8 is a flow chart for closing a tab through the ERT platform. This chart illustrates the flow when a tab has been previously opened and optionally updated one or more times. In this case, the total charge and the descriptor from the open ERT tab may be transmitted to the payment processor. If the charge is accepted in stage 802, the ERT tab may be closed out as charged in stage 805. If the charge is rejected in stage 802, the ERT tab may be closed out as cancelled in stage 810.

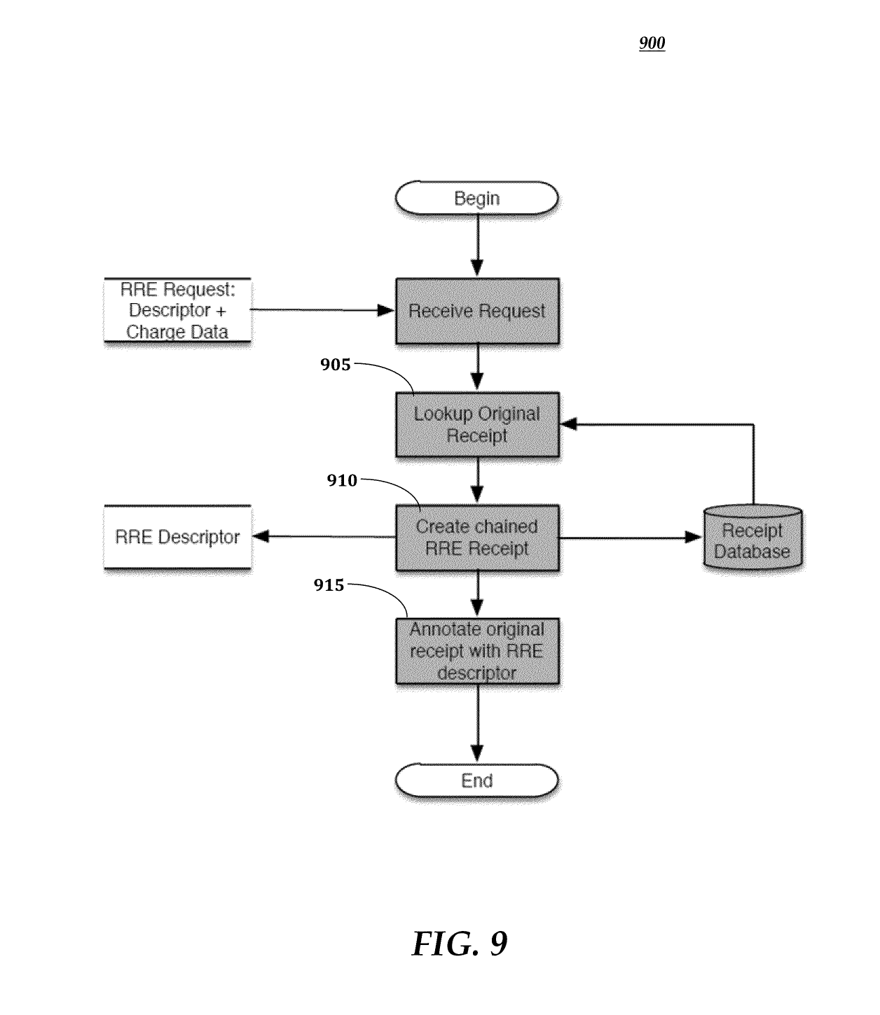

FIG. 9 is a flow chart for handling refunds, returns or exchanges through the ERT platform. In this case, the original receipt is first looked up in the ERT database. Once the original receipt has been located in stage 905, a refund/return/exchange (RRE) receipt may be created with a reference to the original receipt in stage 910, and the original receipt may be annotated with a reference to the RRE receipt in stage 915. An RRE descriptor containing the RGUID may also be created for optional processing by the payment provider.

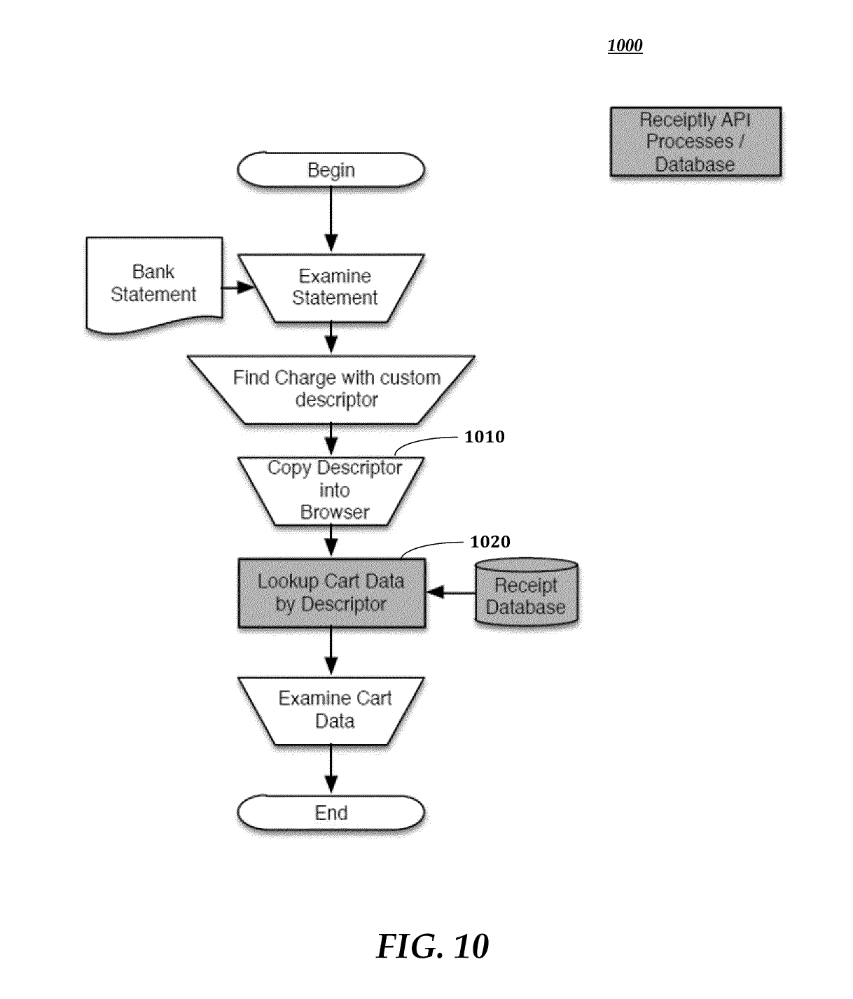

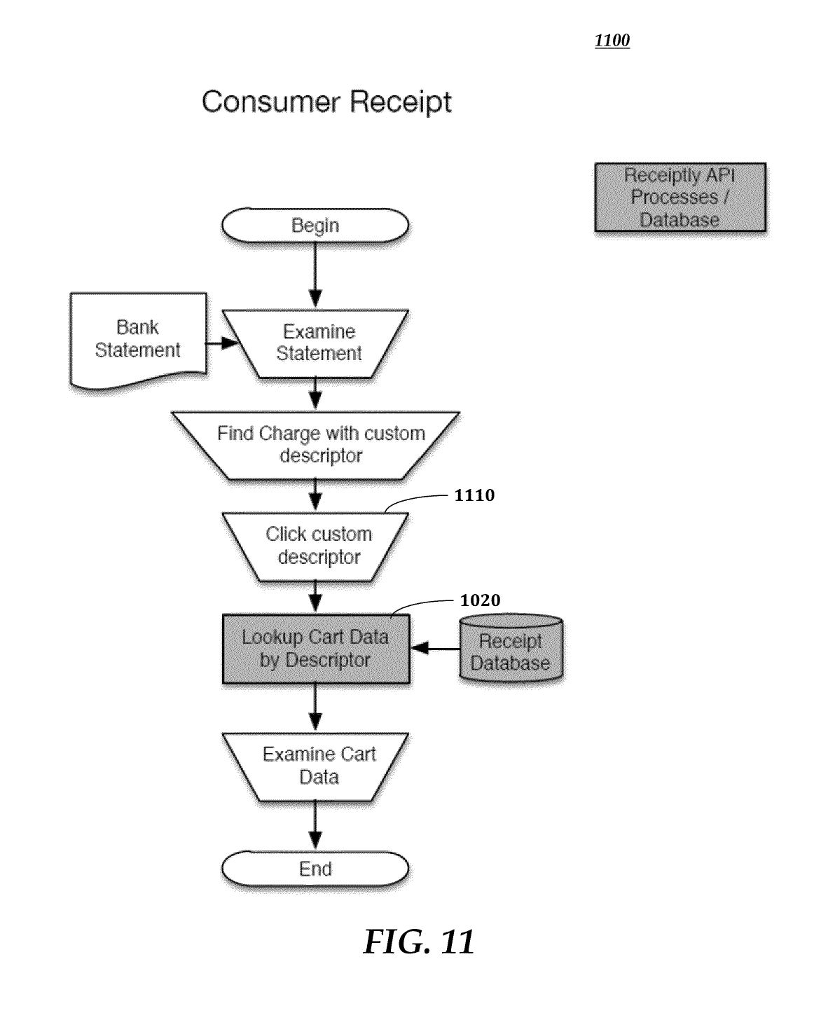

FIGS. 10-11 are flow charts for providing a receipt through the ERT platform. In these charts, a consumer wishes to retrieve detailed information based on a transaction statement from their payment card processor. In FIG. 10, the transaction statement may not provide a web link in the statement and the consumer may copy a statement descriptor into a web browser or other software application in stage 1010 to find the receipt and view detailed cart data when the platform receives the detailed cart data in stage 1020. In FIG. 11, the transaction statement may be accessed on a computer and provide a web link directly to the receipt data, and when the platform receives a link selection from the consumer, in stage 1110, the detailed receipt data may be provided on, for example, a website provided by the ERT system.

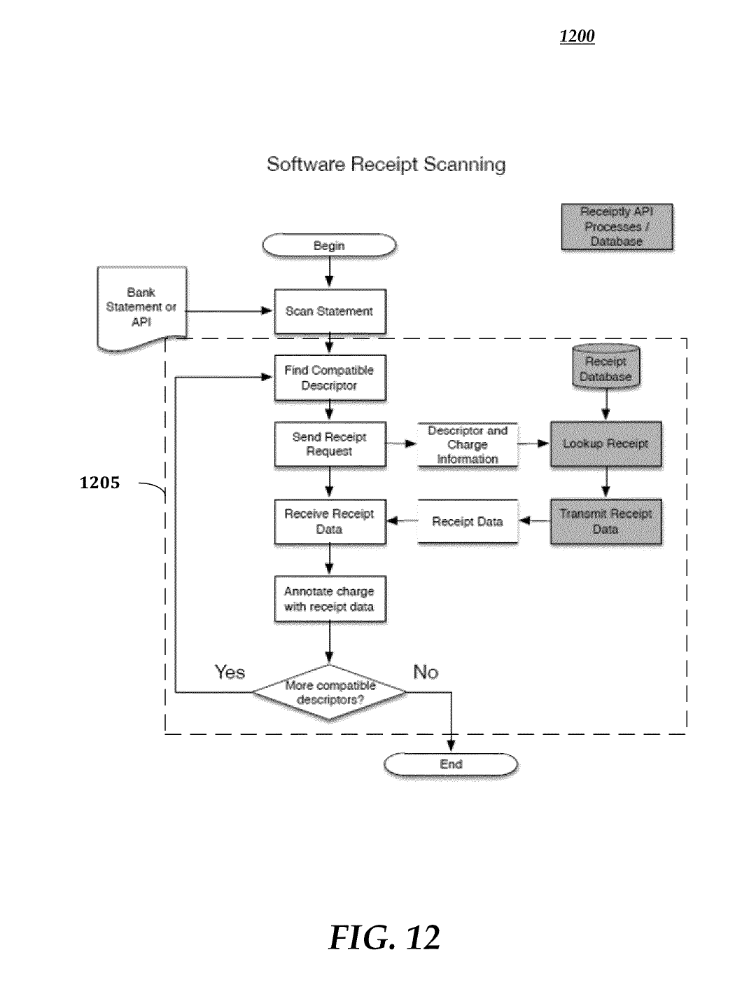

FIG. 12 is a flow chart for receipt scanning through the ERT platform. In this case, a software application (e.g. accounting software, personal finance software, etc.) may receive an electronic statement or retrieve transaction data via an application programming interface. The software application may parse the statement or transactional data to determine a compatible charge descriptor. The software application may then use the compatible charge descriptor to look up receipts and annotate the charge (e.g., within the statement or transactional data) with detailed receipt data (i.e. parsing the data) in stages 1205. This process may be repeated until no further compatible charge descriptors are found.

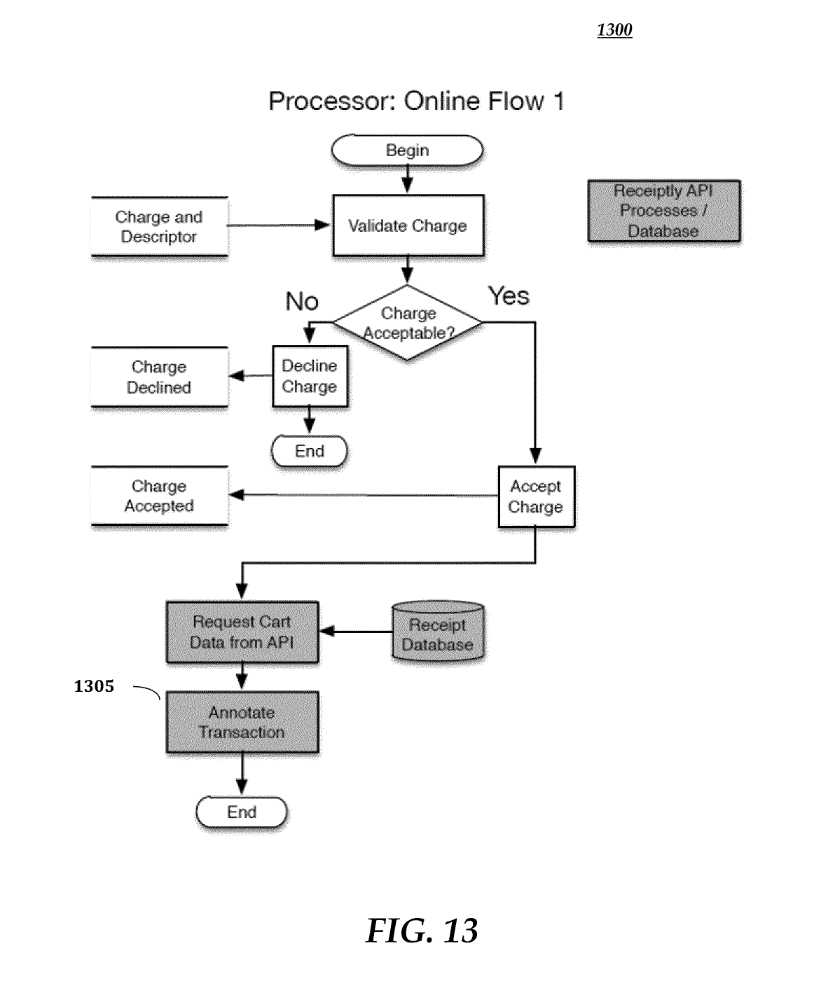

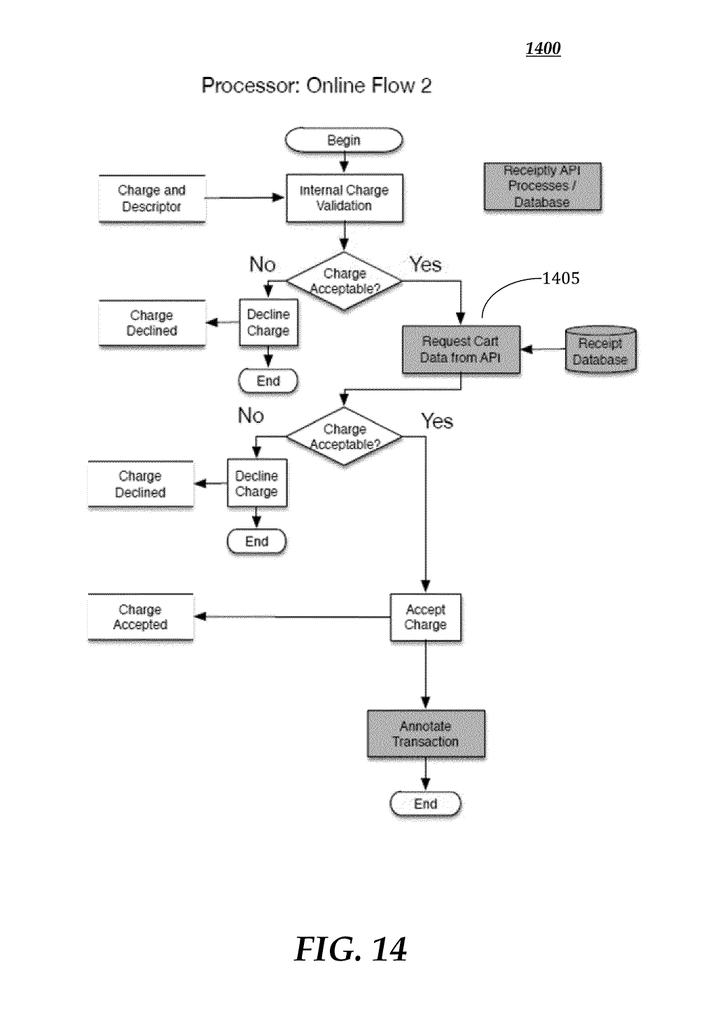

FIGS. 13-14 are flow charts for a payment processor of the ERT platform. In FIG. 13, the payment processor requests detailed receipt data after deciding whether to authorize the charge and simply annotates the charge with receipt data in stage 1305, for example, by embedding the detailed receipt data as metadata. In FIG. 14, the payment processor may use the detailed receipt data as an additional input in stage 1405 when deciding whether to authorize the charge. This decision may encompass risk analysis, policy compliance, or other logic. Once the decision has been made, the processor goes on to annotate the charge with the detailed receipt data as in FIG. 13.

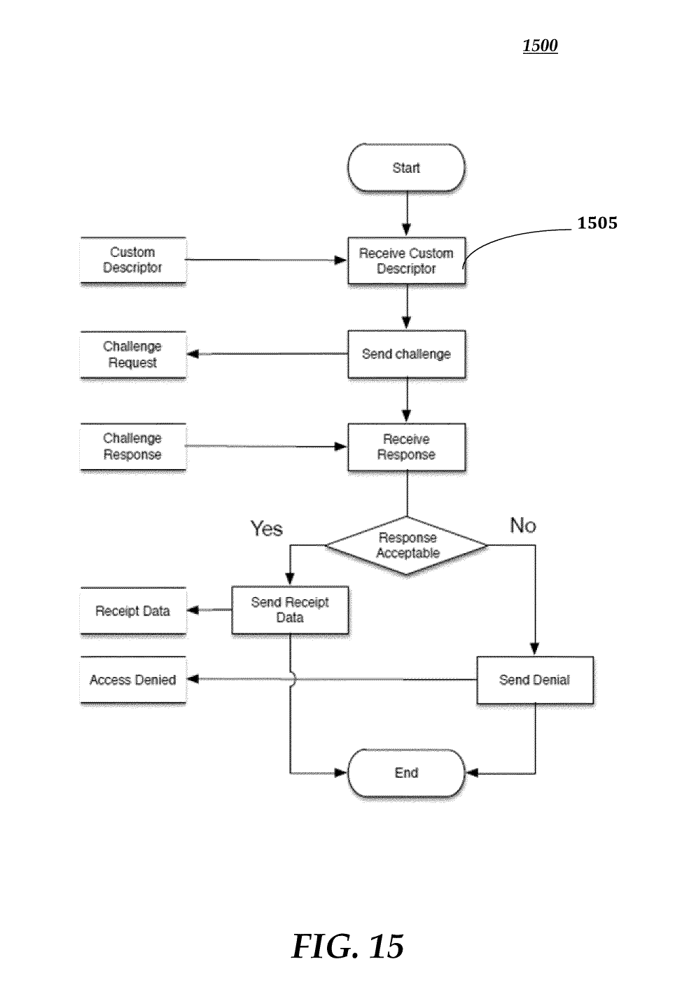

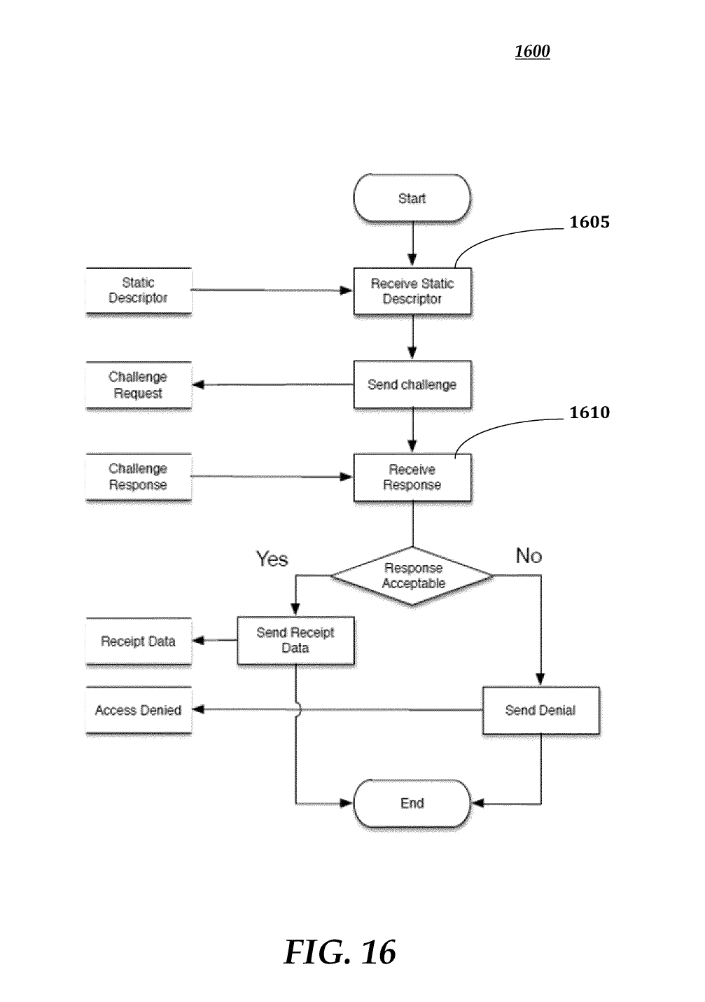

FIGS. 15-16 are flow charts for providing authorization in the ERT platform. In particular, these charts use a challenge/response method to determine authorization to receive receipt data. The challenge comprises a request for information (“authentication information”) that should be known only by any authorized accessor of the data, and may include requests for a portion of the card number, the transaction total, the transaction data, and/or other information. In FIG. 15, the ERT platform may receive the RGUID as part of the dynamic descriptor in stage 1505, and may require less authentication information. In FIG. 16, the ERT platform receives only a static (i.e. not containing an RGUID) descriptor in stage 1605 and may require more authentication information in stage 1610 in order to a) find the RGUID and b) authorize the data requester.

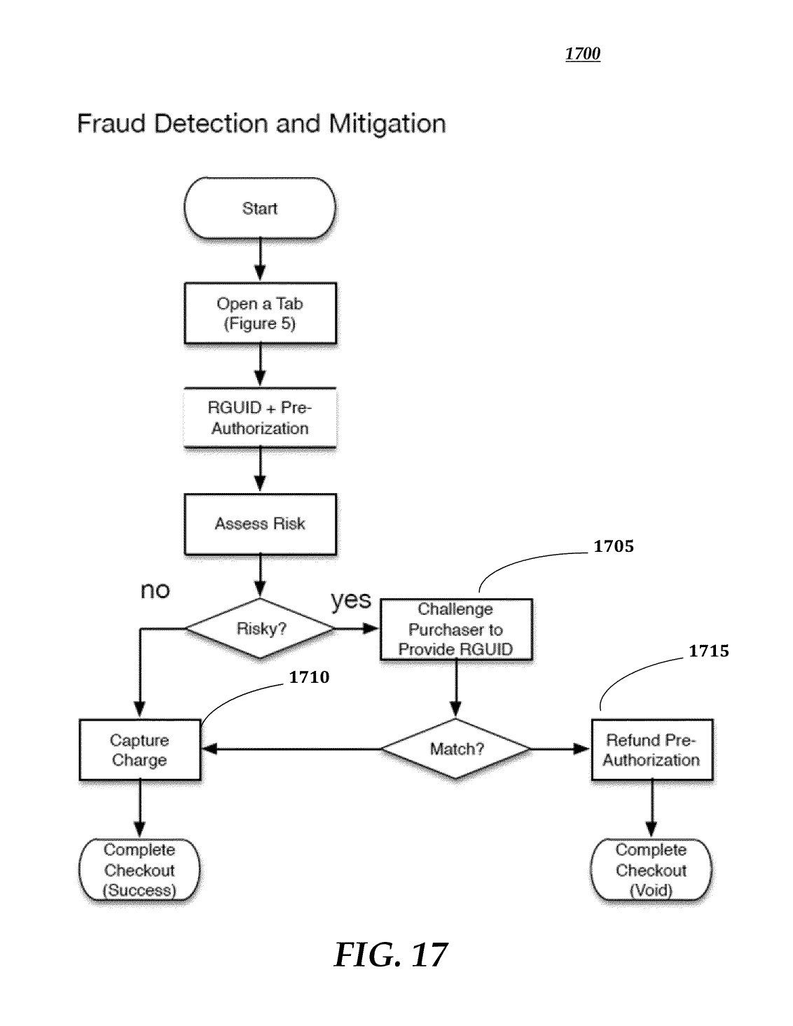

FIG. 17 is a flow chart illustrating using the ERT platform to identify and mitigate fraudulent transactions. When the checkout process begins, a pre-authorization may be performed with the payment processor. The pre-authorization may create a record of the RGUID at the payment processor. If the transaction is identified as risky, the customer may be challenged to provide the RGUID in stage 1705 as authentication. If a correct RGUID is provided, the transaction may be completed successfully by capturing the pre-authorized amount in stage 1710. If the correct RGUID is not provided, the transaction may be failed in stage 1715, and the pre-authorization may be released.

IV. Platform Architecture

The ERT platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although methods have been described to be performed by a computing device 1800, it should be understood that, in some embodiments, different operations may be performed by different networked elements in operative communication with computing device 1800.

Embodiments of the present disclosure may comprise a system having a memory storage and a processing unit. The processing unit coupled to the memory storage, wherein the processing unit is configured to perform the stages of methods disclosed herein.

FIG. 18 is a block diagram of a system including computing device 1800. Consistent with an embodiment of the disclosure, the aforementioned memory storage and processing unit may be implemented in a computing device, such as computing device 1800 of FIG. 18. Any suitable combination of hardware, software, or firmware may be used to implement the memory storage and processing unit. For example, the memory storage and processing unit may be implemented with computing device 1800 or any of other computing devices 1818, in combination with computing device 1800. The aforementioned system, device, and processors are examples and other systems, devices, and processors may comprise the aforementioned memory storage and processing unit, consistent with embodiments of the disclosure.

With reference to FIG. 18, a system consistent with an embodiment of the disclosure may include a computing device, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include ERT application 1820 for providing the software necessary to employ the ERT platform as described above. Furthermore, embodiments of the disclosure may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computer storage media may include volatile and nonvolatile, removable and non-removable media implemented in any method or technology for storage of information, such as computer readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1804, including operating system 1805. While executing on processing unit 1802, programming modules 1806 (e.g., ERT application 1820) may perform processes including, for example, one or more of the flow charts as described above. The aforementioned process is an example, and processing unit 1802 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

The following is claimed:

1. A method comprising:
receiving transactional data;
generating a descriptor to be associated with the transactional data; and
associating the descriptor with the transactional data.

2. The method of claim 1, wherein associating the descriptor with the transactional data comprises:
receiving confirmation that a transaction associated with the transactional data has been processed; and
storing the descriptor with the confirmation.

3. The method of claim 1, wherein generating the descriptor comprises generating a uniform resource locator (URL) associated with an electronic receipt corresponding to the transactional data.

4. The method of claim 1, further comprising:
providing the descriptor to at least one of the following: a user, a group of users, and an account associated with the transactional data.

5. The method of claim 4, wherein providing the descriptor comprises displaying the custom descriptor within a transactional statement associated with at least one of the following: the user, the group of users, and the account associated with the transactional data.

6. The method of claim 4, further comprising:
enabling a selection of the descriptor as a hyperlink pointing to a storage location, the storage location comprising an electronic receipt associated with the transactional data.

7. The method of claim 6, further comprising:
providing the electronic receipt data upon a selection of the hyperlink.

8. The method of claim 1, further comprising:
receiving an open tab indication; and
wherein associating the descriptor with the transactional data comprises associating, in response to the received open tab indication, the descriptor with a plurality of pre-authorized transactions.

9. The method of claim 8, further comprising storing the plurality of pre-authorized transactions and the corresponding descriptor as electronic receipt data.

10. The method of claim 1, further comprising:
parsing transactional data so as to retrieve the descriptor associated with the transactional data;
locating, based on the descriptor, electronic receipt data; and
associating the electronic receipt data with the transactional data.

11. The method of claim 10, wherein associating the electronic receipt data with the transactional data comprises associating the transactional data with a uniform resource locator (URL).

12. The method of claim 11, further comprising:
providing transactional data in conjunction with a URL corresponding to the transactional data.

13. The method of claim 1, wherein receiving the transactional data comprises receiving transactional data pertaining to at least one of the following: a refund and a return.

14. A computer-readable medium comprising a set of instructions which when executed perform a method comprising:
receiving a transactional data;
receiving a descriptor corresponding to the transactional data;
processing a financial transaction associated with the transactional data; and
associating the descriptor with the transactional data.

15. The computer-readable medium of claim 14, wherein associating the descriptor with the transactional data comprises:
parsing transactional data so as to retrieve the descriptor associated with the transactional data;
locating, based on the descriptor, electronic receipt data; and
associating the electronic receipt data with the transactional data.

16. The computer-readable medium of claim 15, wherein associating the electronic receipt data with the transactional data comprises associating the transactional data with a uniform resource locator (URL).

17. The computer-readable medium of claim 16, further comprising:
providing transactional data in conjunction with a URL corresponding to the transactional data.

18. The computer-readable medium of claim 14, further comprising associating the descriptor with at least one of the following: a user, group of users, and an account associated with the transactional data.

19. A system comprising:
A memory storage; and
A processing unit coupled with the memory storage, wherein the processing unit is operative to:
receive transactional data;
generate a descriptor to be associated with the transactional data;
transmit the transactional data to a transaction processor;
receive confirmation that a transaction associated with the transactional data has been processed; and
store the descriptor with the confirmation.

20. The system of claim 19, wherein the processing unit is further operative to associate the transactional data with a uniform resource locator (URL).
